(19) United States
(12) Patent Application Publication
(10) Pub. No.: US 2024/0290175 A1
(43) Pub. Date: Aug. 29, 2024

(54) CONTEST SYSTEM AND METHOD FOR AWARDING PREDETERMINED PRIZES FOR ENHANCED CASUAL PLAYER EXPERIENCE

(71) Applicant: Robert Henry Johnson, Lakewood, WA (US)

(72) Inventor: Robert Henry Johnson, Lakewood, WA (US)

(21) Appl. No.: 18/438,050

(22) Filed: Feb. 9, 2024

Related U.S. Application Data
(60) Provisional application No. 63/486,642, filed on Feb. 23, 2023.

(51) Int. Cl. G07F 17/32

(52) U.S. Cl. CPC G07F 17/3276; G07F 17/3244

(57) ABSTRACT

A select entry is obtained from a competitor. A first-round score for the select entry is computed based on its performance in a first round of a competition. The select entry is ranked relative to a plurality of contest entries based on the score. A head-to-head match for the select entry is established for a second round of the competition based on the ranking. Then, a second score for the contest entry is computed based on its performance in the second round of the competition. A total score for the entry is determined based on the first score and the second score. A prize is computed based on the total score. In response to determining that a count of the plurality of contest entries is above a threshold, the prize is distributed to the competitor.

### TECHNICAL FIELD

The present disclosure relates to the field of competitive contests reward contestants with prizes, and more particularly, to systems and methods for running competitions and awarding prizes to maximize attraction and retention of casual contestants.

### BACKGROUND OF THE INVENTION

Competitive contests are big business in the United States and around the world. In 2021, college athletics' governing body earned $1.15 billion in revenue, with the March Madness tournament representing almost 90% of their revenue. United States reached approximately $105.26 billion spent on lotteries in 2021. Worldwide video game tournament revenue has exceeded 1 billion dollars. In 2018, Gambling revenue in the US exceeded 160 billion dollars, with the gambling industry widely employing tournament systems to attract and retain casual players.

Competitive contests come in a multitude of forms, including bracket tournaments, bracket tournaments with qualifying league play, group competition, group competitions requiring some qualifying action to enter such as a purchase, ladder tournaments, etc. Casual players are important to financial success for many competitive contests. Attracting and retaining casual players is a major concern for competitive contests, tournaments, and games of luck.

Large prizes are effective at creating excitement and attracting new and existing customers to participate in the competitive contests and tournaments. Lotteries in the United States have offered prizes over a billion dollars. But the extremely low odds of winning such a prize carries a risk of discouraging casual players. Whether in contests of chance or skill, contests give up some degree of participation when players feel the odds are too stacked against them.

Though most players in many contests are casual players, it is difficult to retain casual players. An important issue to casual player retention is the fact that most casual players lose and do not win any prizes. As casual players feel defeated or believe they cannot win, they tend to discontinue participating. For example, the odds of picking a perfect March Madness bracket, which pays up to a million dollars, is approximately one in 100 billion. So, if everyone on the planet filled out a different bracket, we would almost certainly still not have a perfect bracket or a winner. These stark odds may create large payouts but fail to maximize participation.

A well-known solution to mitigate this tradeoff uses progressive prizes. Once progressive prizes become large, they become successful at attracting new and existing casual players to start participating in the contest or tournament, but the effect is short lived. Once the progressive large prizes are paid and the progressive prize is reset to a lower sustainable starting amount the participation rate drops considerably.

Different handicapping schemes also exist to enable casual players to participate in contests. These handicapping schemes are often exploited by the seasoned players through sandbagging and other methods leading to the seasoned players still winning most of the prizes. A new solution is needed to maintain high contest participation and engagement for casual players.

### Definition of Terms

A Contest is a competition wherein two or more contestants compete.

A Prize Event is an event in which prizes are awarded to contestants.

A Skilled Contest is a contest that that is based on mostly skill, such as a foot race, trivia, and the like.

A Semi-Skilled contest is a contest based on skill and luck such as poker, fantasy sports, and the like.

A Luck Contest is a contest solely based on luck, such as a lottery, where contestants compete to guess the correct numbers that will be drawn in the future.

A Seasoned Player is a player who regularly competes in a contest and substantially commits to competing in the contest.

A Casual Player is a player who is not a Seasoned Player.

### Casual Player Retention

The main reason most casual players lose is different for skilled and semi-skilled contests verses contests of luck. With Contests of Skill or Semi-skill, over time the seasoned players win the majority of all prizes, leaving causal players feeling defeated and unable to win.

With Contests of Luck the odds of winning a prize is low leading to most casual players failing to win a prize. For every casual player that wins some sort of prize in the Mega-Millions Lottery, 23 casual players lose and win nothing.

The present disclosure changes the dichotomy of current and previous art, from “the greater number of casual players who compete the greater number casual players who lose” versus “as more casual players compete the greater number of casual players who win” thus increase revenues by increasing the trust players have of winning more often. Looking at the year 2019, Mega Millions managed to sell 1,480,538,245 (or 1.48 billion) tickets. This massive number of tickets relates to $2.96 billion worth of sales when considering that a single ticket costs $2. The results of these 1,480,538,245 tickets are as follows:

| | | |
|---|---|---|
| Total Tickets sold | 1,480,538,245 | |
| Winning Tickets | 61,689,094 | 4.2% |
| Losing Tickets | 1,418,849,151 | 95.8% |

For a small fee per entry, as little as $1, the embodiments described herein could turn over 1.4 billion losing lottery tickets into over 700 million winning lottery tickets, generating revenues of over 1.4 billion dollars and provide ongoing top prizes in the hundreds of millions of dollars. This would increase Mega Millions' lottery profits and engage causal players adding greater entertainment, new strategies and increase the opportunity casual players have to win.

### Improvement to Efficiency of Competition Computers

Implementations of the present disclosure increase player retention and facilitate streamlining multiple rounds of competition. By automatically ranking competitors at a plurality of points during a competitive game, contestants are iteratively placed against those with similar performance in the previous round. This allows contestants' true skill to be determined in fewer rounds, reducing computing costs. Furthermore, the queue-based format of the competition allows competitors to enter and exit the competition

For example, in a traditional bracket-based competition with high skill variance, one dominant seasoned player may defeat many casual players before facing a similarly skilled opponent. This is computationally inefficient, as little information about the skilled players' skill level can be obtained by facing many unskilled casual players.

### New and Unique Scoring and Match-Making System

Performance levels of most contestants throughout a contest do not remain steady; for example, a runner running a five-mile race will have a different time of completion for each mile of the race but will be judge on the final time of the complete 5-mile race. The present disclosure uses a fairer way of determining winners and losers.

According to one or more embodiments described herein, this is accomplished by all competitions being broken down into scoring segments, for example, the five-mile race would have five scoring segments or score data points. Each score data point would be the time to complete one mile of the five-mile race. Each head-to-head competition uses only one of these data points to determine the winners and losers. At no time is the final scores or final results used to determine winners and losers

The present disclosure places equally skilled players against each other in head-to-head competitions to increase the number of players winning at all skill level.

This is accomplished by using the final score to sort all player from the worst performing to the best performing player. Then the two worst players are submitted to the head-to-head competition and then the next two worst players are submitted and so on until all players have entered the head-to-head contest.

The present disclosure is designed to take full advantage of cloud computing for speed and processing capabilities. One or more embodiments described herein can economically accept, process and report results for large volumes of electronic entries. The present disclosure is capable of economically supporting micro-tournaments with entry fees under a dollar to tournaments with fees in the hundreds of dollars.

### SUMMARY OF THE INVENTION

Implementations of the present disclosure are directed toward systems and methods of dynamically dividing a contest into a plurality of rounds, matching contestants based on a performance in each round, and automatically distributing a plurality of prizes across performance brackets at predetermined points in the contest. A system continuously collects electronic competition entries from competitors. These entries are placed in a queue.

The contest is divided into at least one round, wherein each round assesses a performance of a contestant's entry. Each round contains at least one level. At each level, a score of one entry is compared to the score of another entry. The entry with the higher score continues to the next level, while the entry with the lower score is removed from the round. Head-to-head comparison of entry scores is done on a continuous basis. For example, if only one entry is received at level 1, the system waits until another entry is received at level 1. Then, the entry with the higher score wins and is promoted to level 2. The system must receive two more entries at level 1 before the winning entry in level 2 can be compared, as only one of every two entries at level 1 wins and advances to level 2. This principle extends to all levels in a round, such that four entries must be received before a level 2 comparison can be made, eight entries must be received before level 3 comparison can be made, and so on. Because of this feature, prizes can be set for each round knowing exactly how many competitors must enter before a payout of the prize is possible. For instance, in a round with eight levels, 256 entries must be received before a winner can be declared. This number can be further tuned by changing the number of entries that are compared at each level or changing the number of levels in each round. Each round may in some implementations only consist of winners of the previous round. Entries may be scored instantaneously as soon as enough entries are received, on a regular schedule, to fit with advertising breaks in program, and the like.

A contest may feature multiple rounds of competition before it concludes. Continuing the example above, 256 entrants from the first round is reduced to 1 entrant for the second round. This allows for extremely large numbers of entries to be accommodated. Still, the number of entries necessary to conclude the competition is known beforehand. This allows prizes to be set to maximize casual player retention and engagement. For example, some implementations feature payouts at various points during competition, allowing more players to win, and decreasing frustration and loss of competitors. Prizes can be advertised before the competition begins, with confidence that the prize obligation will be met. Prizes can be set in the billions of dollars without any risk. The billion-dollar prize will be awarded only after enough entries have been submitted to fund the prize.

Because performance is assessed on a continuous per-round basis and the number and size of performance brackets is dynamic, implementations of the present disclosure accommodate an arbitrary number of entries received throughout the competition.

Implementations described herein can improve the operation of contest computing systems. Automatically matching contestants within contest to be completed with fewer rounds, as more performance-balanced rounds provide higher quality information about a contestant's performance. This saves computing resources, which are not committed to low quality rounds. Performance-balanced rounds increase retention of casual players, which reduces the total number of separate communication channels that must be established and maintained as new contestants replace quitting contestants. Performing contests more rapidly frees computing resources which can be redeployed as desired.

### BRIEF DESCRIPTION OF THE DRAWINGS

FIG. 1 shows an implementation of a system of the present disclosure.

FIG. 1a illustrates the flow of electronic entry and the returning of the competitive entry results.

FIG. 2 shows an implementation of examples of the electronic entries data objects for the present disclosure.

FIG. 3 shows an implementation of the overall flow of the handicapping and seeding system and the score data point 1 head-to-head entry match.

FIG. 4 shows an implementation of the flow for the Head-to-Head score data point entry matches.

FIG. 4a shows an implementation of the flow for round 1 of the Head-to-Head score data point entry matches.

FIG. 4b shows an implementation of the flow for round 2 of the Head-to-Head score data point entry matches.

FIG. 4c shows an implementation of the flow for round 3 of the Head-to-Head score data point entry matches.

FIG. 5 shows two examples of the electronic entry results data objects for this disclosure.

FIG. 6 shows an implementation of the procedures for dealing with multiple electronic entries.

FIG. 7 shows an implementation of the flow of continuous electronic entries and results.

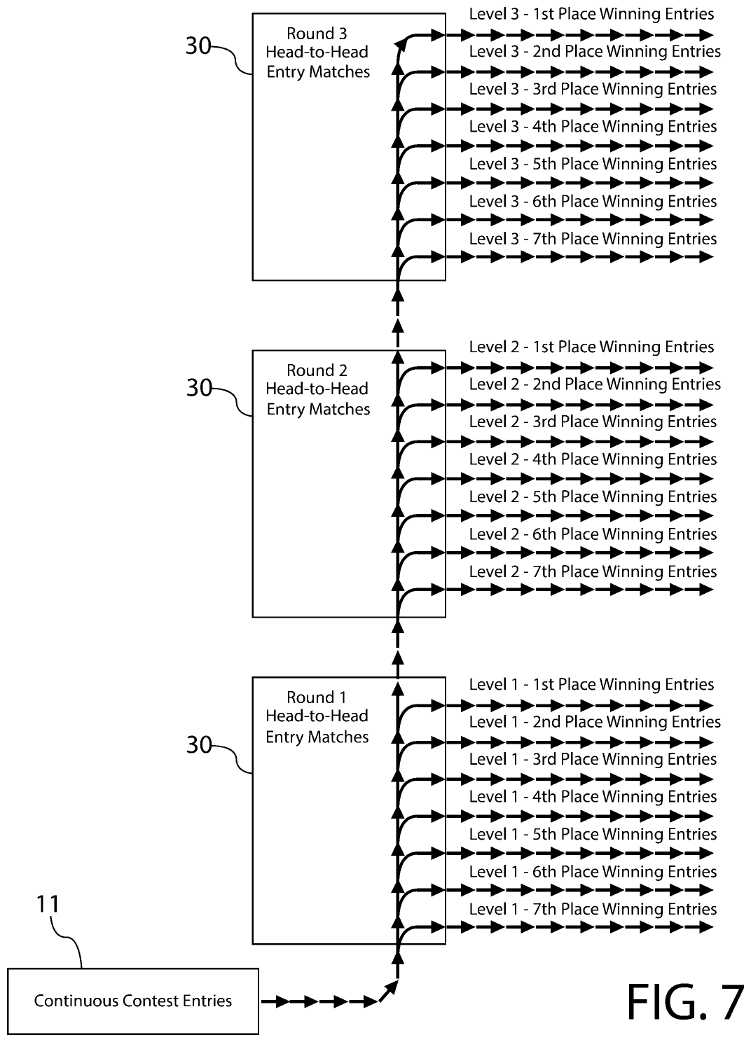

FIG. 8 show an implementation of the components in the system.

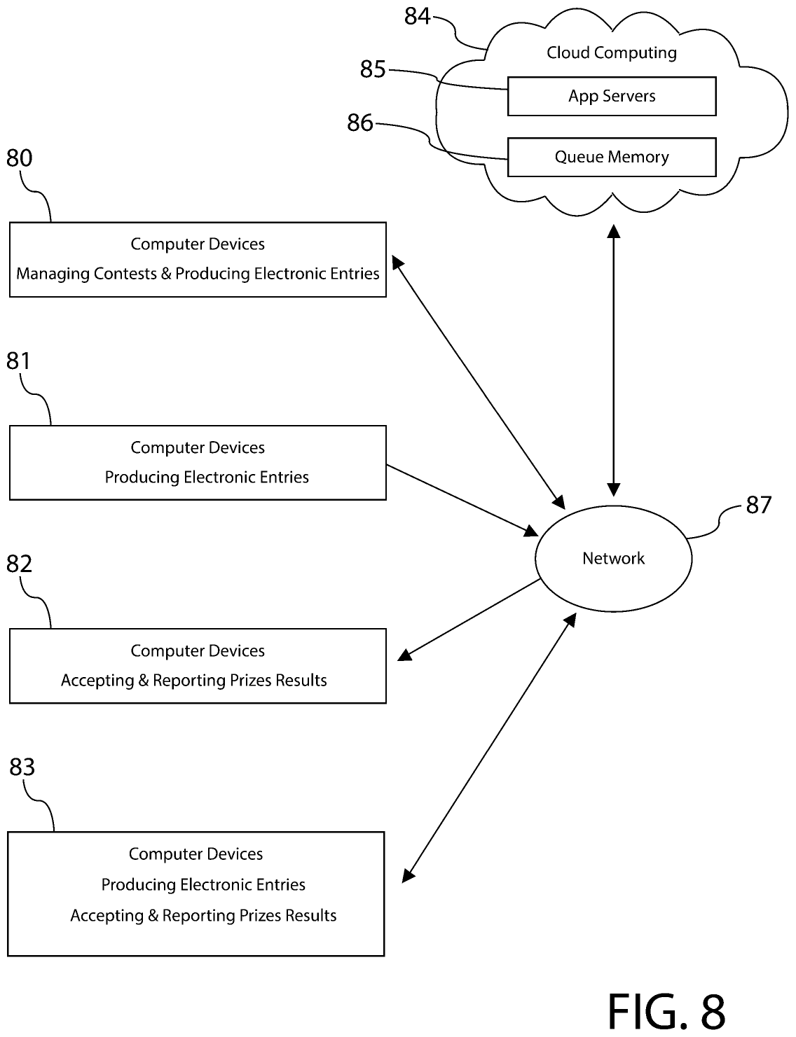

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

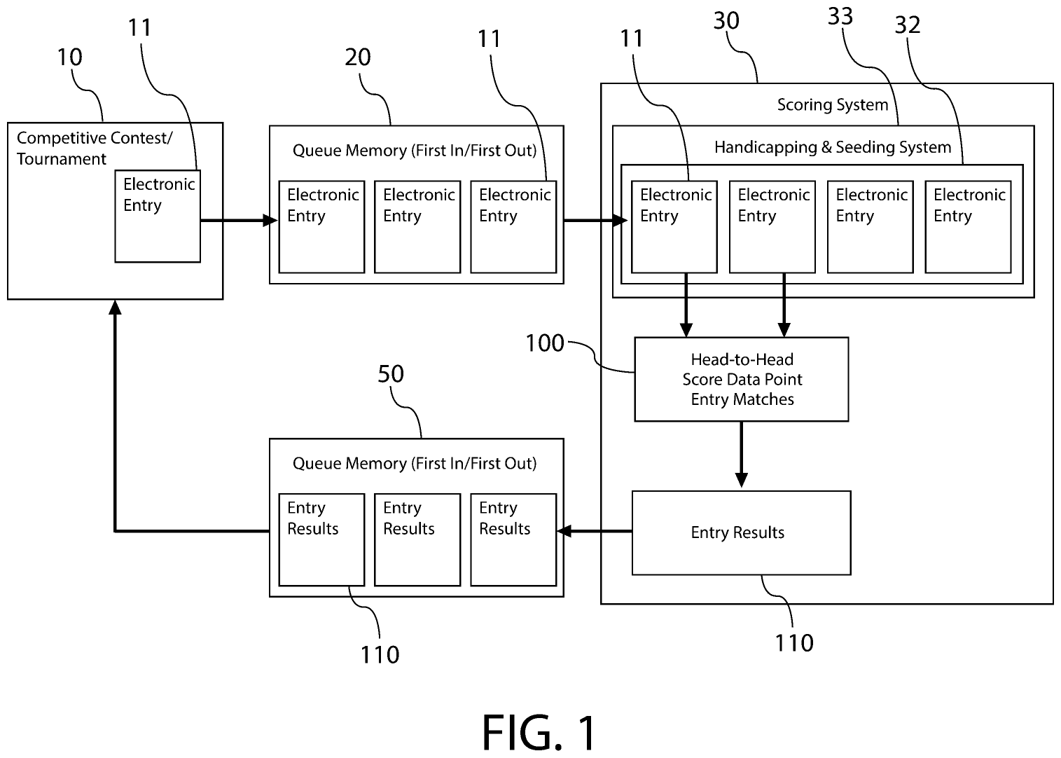

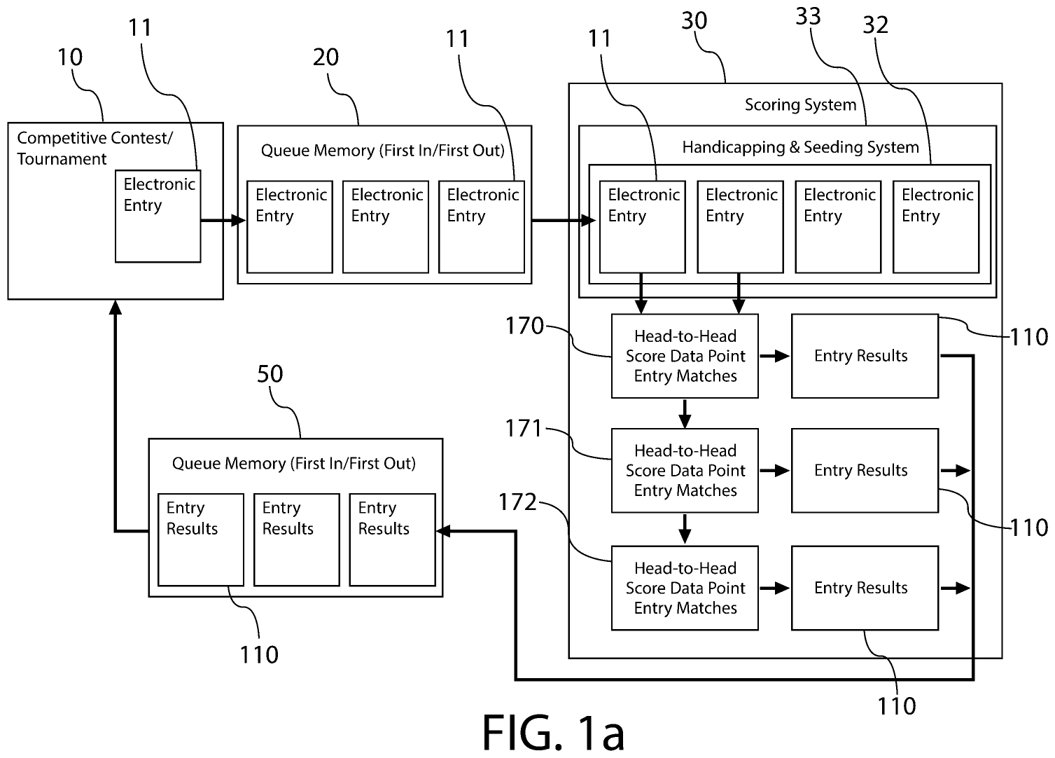

FIG. 1a illustrates the flow of electronic entry 11 and the returning of the competitive entry results 110. The competitive contest 10 creates electronic entries 11 and pulling entry results 110 data objects from the results queue 50. The competitive contest 10 is also able to submit an electronic entry 11 that represents multiple tournament entries. Multiple tournament entries may use the same score data points and total score contained in the electronic entry 11 for competing in the head-to-head matches 170.

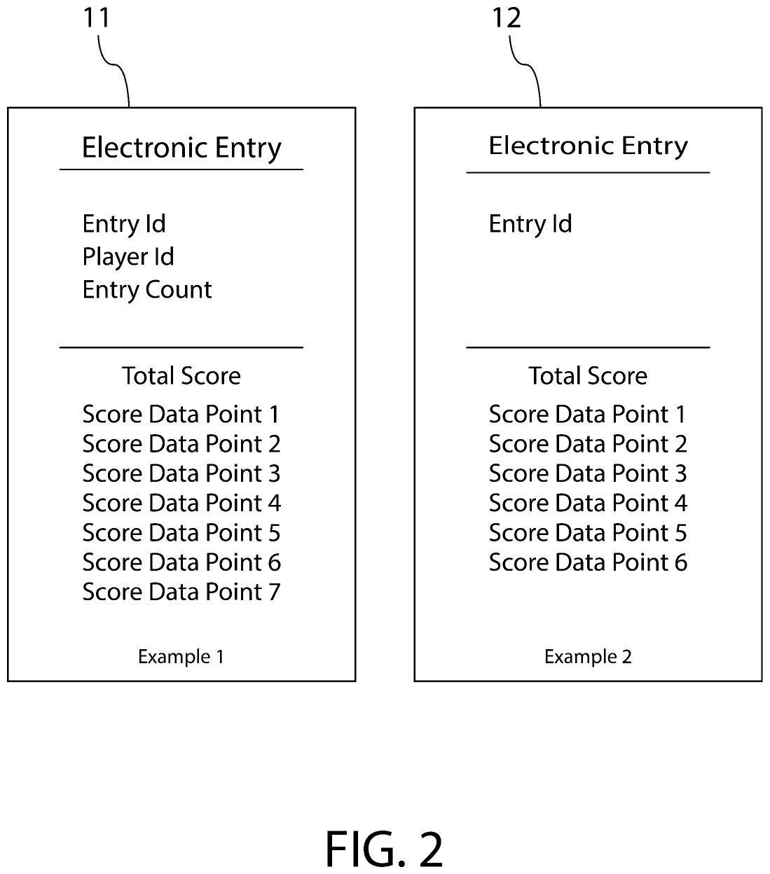

In this implementation, the competitive contest 10 is a web app, and this app may run in multiple web browsers and functions on numerous devices that have web browsers such as mobile devices and computer systems. Once a contestant completes the competitive contest 10 an electronic entry 11 is created in the form of a data object. For this embodiment, the data object, which is described in FIG. 2 under reference numeral 11, includes the following: seven scoring data points, a total score, which is the total of all the seven score data points added together, an entry Id, a player Id, and an entry count of 1 or more.

Upon completion of the electronic entry 11, it is transmitted through a network, in this embodiment the internet, to the scoring queue memory 20 that is maintained in the cloud. The scoring queue memory 20 collects all the electronic entries 11 submitted by the competitive contest 10 in an order, where the first electronic entry 11 submitted is the first electronic entry 11 pulled out by the scoring system 30.

The scoring system 30 may include a handicapping and seeding system 33 that uses the total score value as a handicapping tool and a system for head-to-head score data point entry matches 170. These head-to-head matches use the electronic entry's 11 scoring data points for determining winners and losers. The head-to-head entry matches 170 also produces the entry results data object 110.

The handicapping and seeding system 33 pulls groups of electronic entries 11 from the scoring queue memory 20 and then sorts the electronic entries 11 based on their total score value. This produces a sorted list 32 of electronic entries 11 with the lowest total score to the highest total score. The electronic entries 11 with the two lowest total scores are submitted to the first round head-to-head score data point entry matches 170.

The head-to-head score data point entry matches 170 creates an entry results data object 110 once an electronic entry 11 has been eliminated or in this embodiment, when an electronic entry 11 has successfully defeated seven other electronic entries. The entry 11 that has successfully defeated seven other electronic entries in round one head-to-head score data point entry matches 170 is submitted to the second round of head-to-head score data point entry matches 171.

Here again, the head-to-head score data point entry matches 171 create an entry results data object 110 once an electronic entry has been eliminated or in this embodiment, when an electronic entry 11 has successfully defeated seven other electronic entries. The entry 11 that has successfully defeated seven other electronic entries in the second round head-to-head score data point entry matches 171 is submitted to the third round of head-to-head score data point entry matches 172.

Here again, the head-to-head score data point entry matches 172 create an entry results data object 110 once an electronic entry 11 has been eliminated or in this embodiment, when an electronic entry 11 has successfully defeated seven other electronic entries.

Upon creation of the entry results data object 110, the head-to-head score data point entry matches 172 transmits the entry results data object 110 to the results queue memory 50 that is maintained in the cloud based on the player Id.

In this implementation the results queue 50 includes multiple queues equal to the number of competitors competing. Each queue corresponds to a single competitor. When a single competitor accesses the competitive contest 10, that competitor can cause the competitive contest app 10 to retrieve the entry results. The competitive contest 10 is responsible for awarding the prizes to the competitors based on their entry results. Prizes may be automatically modified by the system, as will be discussed with respect to FIG. 1.

This implementation is an ongoing competitive contest 10 and scoring system 30, which is designed to operate continuously, processing, scoring and returning results for an unlimited number of electronic entries 11.

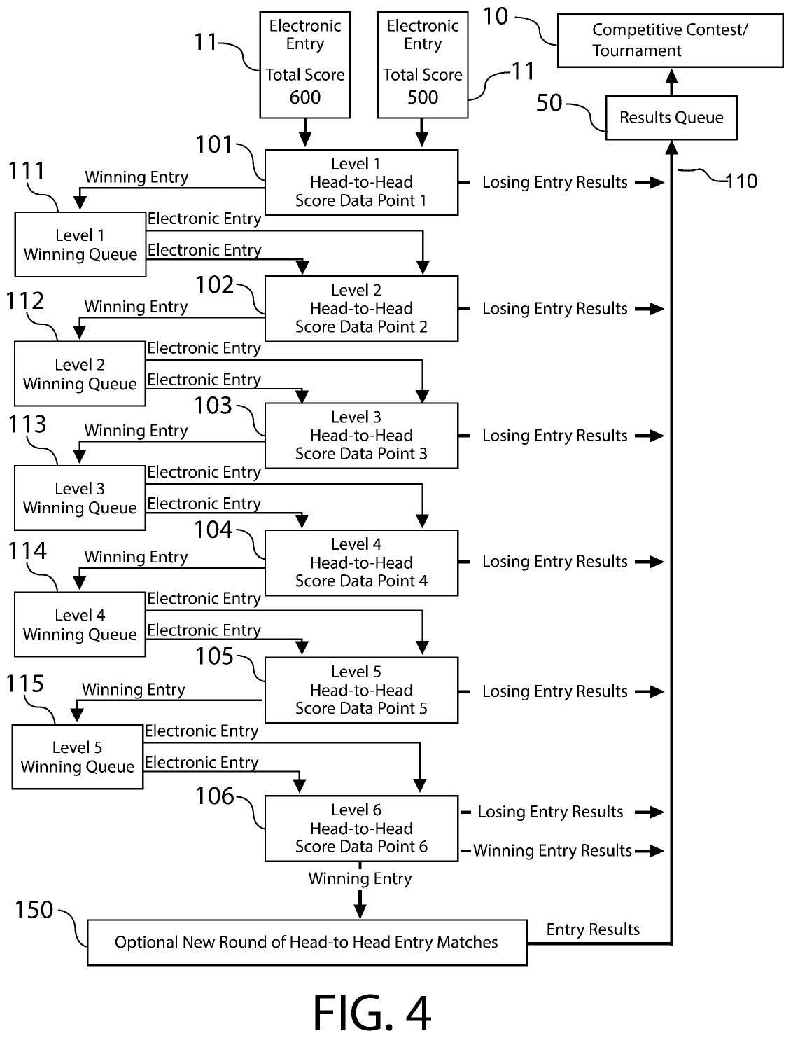

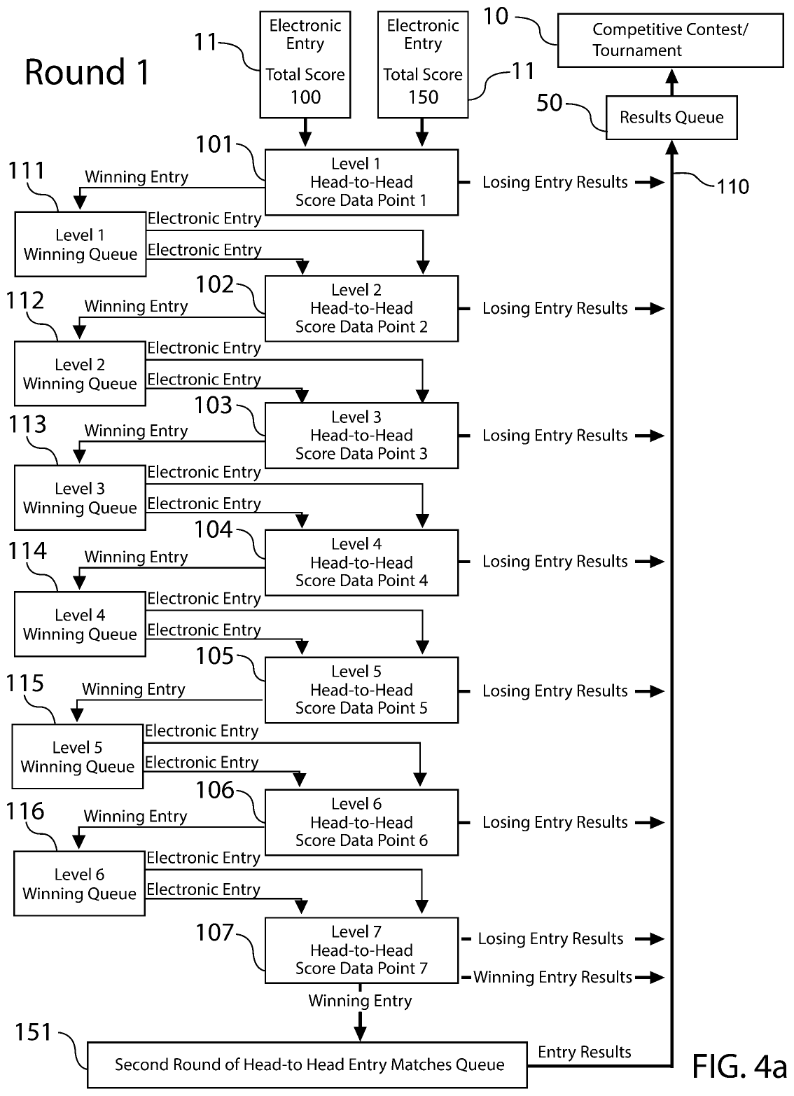

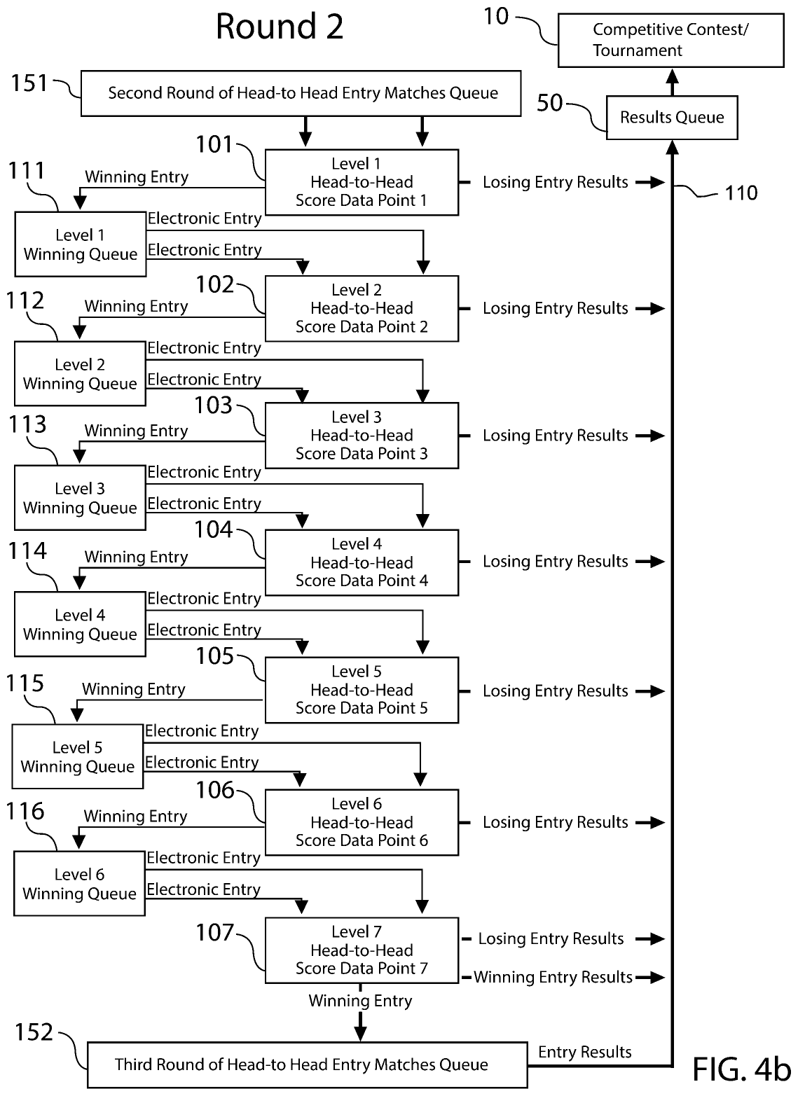

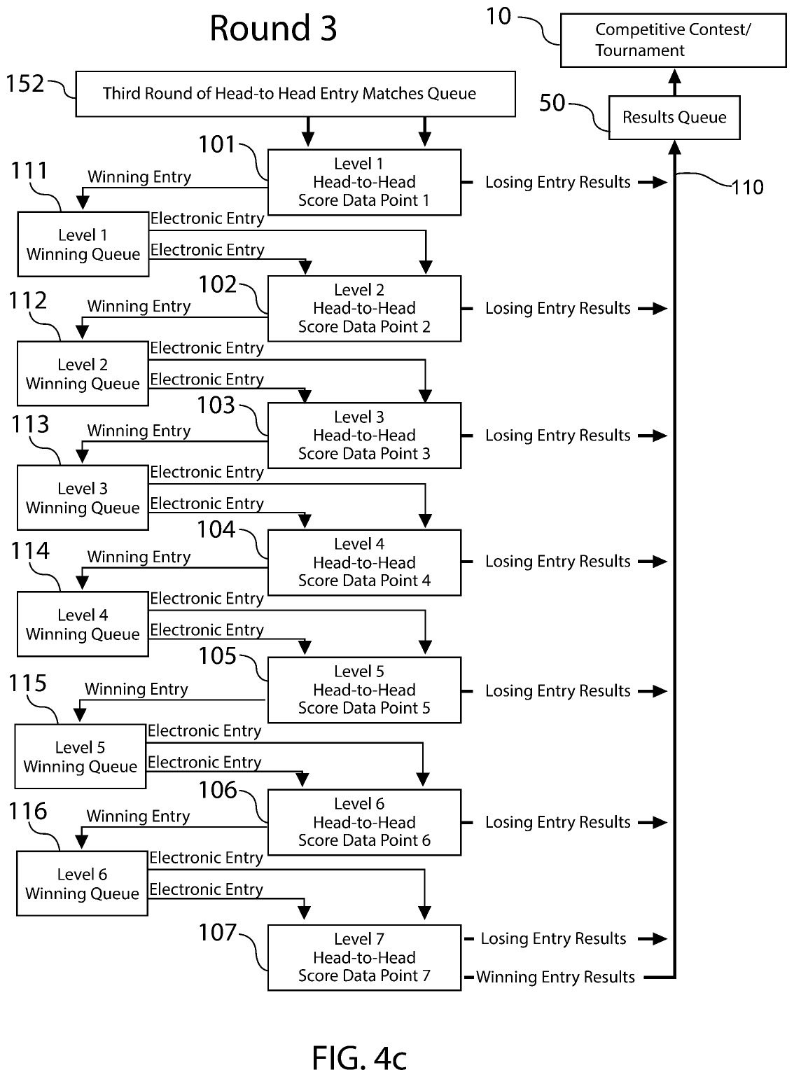

This implementation is configured to have one or more rounds of head-to-head score data point entry matches. Multiple rounds of head-to-head matches 100 may be used to enable offering larger tangible prizes. In the implementation depicted in FIG. 1a, there are three rounds of head-to-head score data point entry matches 170, 171, and 172. FIGS. 4a, 4b, and 4c depict each of these three rounds, respectively.

The number of rounds is in some implementations determined dynamically by the system and may depend upon a variety of factors, such as the intended duration of the contest, anticipated number of entrants, desired size of the prize pool, geographic location of the competitors, and the like.

FIG. 2 depicts implementations of two electronic entries. Electronic entries can be modified with custom data to fit the needs of different types of competitive contests, but for the embodiments or implementations described herein, they must contain at a minimum an entry id, a player id, entry count, a total score and at least two score data points.

For this implementation, the present disclosure uses electronic entry 11 and requires the following data types: an entry id-which is a unique identifier; a player Id-a unique identifier for the submitting contestant; an entry count—the number of entries that is represented by this electronic entry 11; a total score—the combined score of all score data points; and a score data point—the score for a selected part of the competitive contest. This implementation uses seven score data points and each data point represents the results and score of 1/7^{th} of the competitive contest. Meanwhile, electronic entry 12 only includes an entry id, a total score, and six score data points.

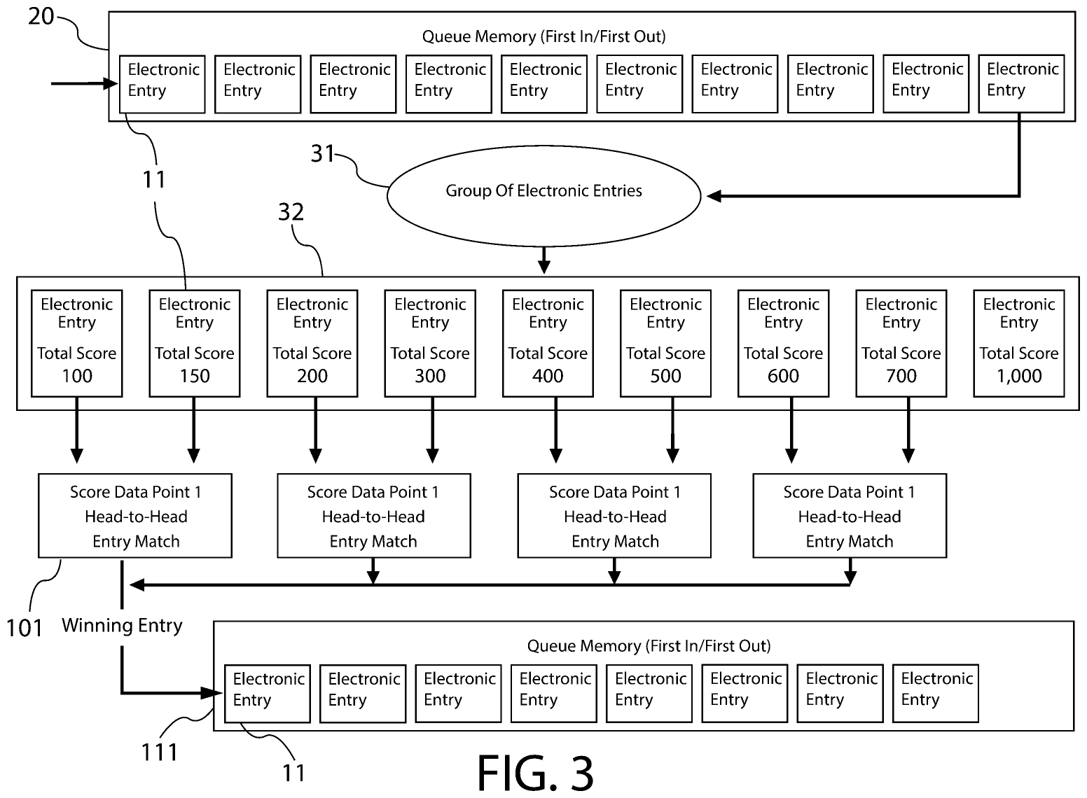

FIG. 3 depicts the overall flow of the handicapping and seeding system and the score data point 1 head-to-head entry match. FIG. 3 shows the electronic entries 11 waiting in the scoring queue memory 20. The handicap and seeding system pull a group of electronic entries 31 and then sorts 32 them by total score from smallest total score to the highest total score. Then the first two lowest scored electronic entries 11 are submitted to the score data point 1 head-to-head entry match 101 where the value of the score data point 1 of each electronic entry 11 is compared to find a winner. The winning electronic entry 11 is the placed into the level 1 winning queue 111.

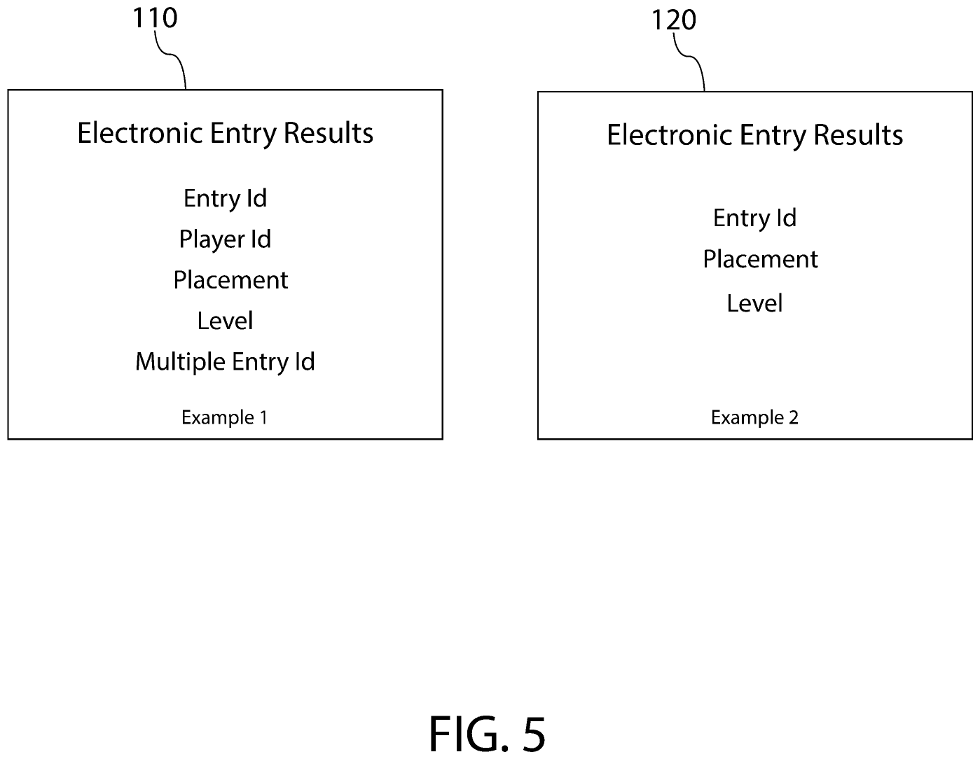

FIG. 5 shows two electronic entry results data objects. This implementation uses example 1 of the electronic entry results data object 110, which contains the following data: Entry Id-which is a unique identifier for the entry; Player Id-a unique identifier for the submitting contestant; Placement-which can have a value of 1^{st} to 8^{th} placement; Level—represents which round the placement was earned; Multiple Entry Id-represents which 11 electronic entry this is in a group of multiple entries. This value is set to one when only a single 11 electronic entry is submitted.

FIG. 4a shows the flow for round 1 of the Head-to-Head score data point entry matches discussed in detail with respect to each level:

### Round 1-Head-to-Head Score Data Point Matches

### Level 1

When two electronic entries 11 are submitted to level 1 head-to-head score data point 1 matchup 101, the score data point 1 value of both electronic entries 11 are compared. If the first electronic entry's 11 score data point 1 value is equal to/or greater than the second electronic entry's 11 score data point 1 value then the first electronic entry 11 wins. If not, then the second electronic entry 11 wins.

The winning entry is submitted to the level 1 winning queue 111. The losing electronic entry 11 is eliminated and an entry results data object 110 is created with the losing electronic entry data 11, entry id, player id, multiple entry id and the level value set to 1 and the placement value set to 8. The entry results data object 110 is sent to the results queue 50 corresponding to the player id value of the eliminated electronic entry 11.

### Level 2

When two or more electronic entries 11 are present in the level 1 winning queue 111, the first two electronic entries 11 are submitted to the level 2 head-to-head score data point 2 102 match. Then the score data point 2 value of both electronic entries 11 are compared. If the first electronic entry's 11 score data point 2 value is equal to/or greater than the second electronic entry's 11 score data point 2 value, then the first electronic entry 11 wins. If not, then the second electronic entry 11 wins. The winning entry is submitted to the level 2 winning queue 112. The losing entry is eliminated and an entry results data object 110 is created with the losing electronic entry data 11, entry id, player id, multiple entry id and the level value set to 1 and the placement value set to 7. The entry results data object 110 is sent to the results queue 50 corresponding to the player id value of the eliminated electronic entry 11.

### Level 3

When two or more electronic entries 11 are present in the level 2 winning queue 112, the first two electronic entries 11 are submitted to the level 3 head-to-head score data point 3 103 match. Then the score data point 3 value of both electronic entries 11 are compared. If the first electronic entry's 11 score data point 3 value is equal to/or greater than the second electronic entry's 11 score data point 3 value, then the first electronic entry 11 wins. If not, then the second electronic entry wins 11. The winning entry is submitted to the level 3 winning queue 113. The losing entry is eliminated and an entry results data object 110 is created with the losing electronic entry 11 data, entry id, player id, multiple entry id and the level value set to 1 and the placement value set to 6. The entry results data object 110 is sent to the results queue 50 corresponding to the player id value of the eliminated electronic entry 11.

### Level 4

When two or more electronic entries 11 are present in the level 3 winning queue 113, the first two electronic entries 11 are submitted to the level 4 head-to-head score data point 4 104 match. Then the score data point 4 value of both electronic entries 11 are compared. If the first electronic entry's 11 score data point 4 value is equal to/or greater than the second electronic entry's 11 score data point 4 value, then the first electronic entry 11 wins. If not, then the second electronic entry 11 wins. The winning entry is submitted to the level 4 winning queue 114. The losing entry is eliminated and an entry results data object 110 is created with the losing electronic entry 11 data, entry id, player id, multiple entry id and the level value set to 1 and the placement value set to 5. The entry results data object 110 is sent to the results queue 50 corresponding to the player id value of the eliminated electronic entry 11.

### Level 5

When two or more electronic entries 11 are present in the level 4 winning queue 114, the first two electronic entries 11 are submitted to the level 5 head-to-head score data point 5 105 match. Then the score data point 5 value of both electronic entries 11 are compared. If the first electronic entry's 11 score data point 5 value is equal to/or greater than the second electronic entry's 11 score data point 5 value, then the first electronic entry 11 wins. If not, then the second electronic entry 11 wins. The winning entry is submitted to the level 5 winning queue 115. The losing entry is eliminated and an entry results data object 110 is created with the losing electronic entry 11 data, entry id, player id, multiple entry id and the level value set to 1 and the placement value set to 4. The entry results data object 110 is sent to the results queue 50 corresponding to the player id value of the eliminated electronic entry 11.

### Level 6

When two or more electronic entries 11 are present in the level 5 winning queue 115, the first two electronic entries 11 are submitted to the level 6 head-to-head score data point 6 106 match. Then the score data point 6 value of both electronic entries 11 are compared. If the first electronic entry's 11 score data point 6 value is equal to/or greater than the second electronic entry's 11 score data point 6 value, then the first electronic entry 11 wins. If not, then the second electronic entry 11 wins. The winning entry is submitted to the level 6 winning queue 116. The losing entry is eliminated and an entry results data object 110 is created with the losing electronic entry 11 data, entry id, player id, multiple entry id and the level value set to 1 and the placement value set to 4. The entry results data object 110 is sent to the results queue 50 corresponding to the player id value of the eliminated electronic entry 11.

### Level 7

When two or more electronic entries 11 are present in the level 6 winning queue 116, the first two electronic entries 11 are submitted to the level 7 head-to-head score data point 7 107 match. Then the score data point 7 value of both electronic entries 11 are compared. If the first electronic entry's 11 score data point 7 value is equal to/or greater than the second electronic entry's 11 score data point 7 value, then the first electronic entry 11 wins. If not, then the second electronic entry 11 wins. The winning entry is submitted to the second round head-to-head entry matches queue 151 and a results data object is created with the winning electronic entry's 11 data, entry id, player id, multiple entry id and the level value is set to 1 and the placement value set to 1. The entry results data object 110 is sent to the results queue 50 corresponding to the player id value of the winning electronic entry 11. The losing entry is eliminated and an entry results data object 110 is created with the losing electronic entry 11 data, entry id, player id, multiple entry id and the level value set to 1 and the placement value set to 2. The entry results data object 110 is sent to the results queue 50 corresponding to the player id value of the 11 eliminated electronic entry. The number of levels and rounds may vary and is by no means limited to the description above.

FIG. 4b shows an implementation of the logic flow for round 2 of the head-to-head score data point entry matches:

### Round 2-Head-to-Head Score Data Point Matches

### Level 1

When two or more electronic entries 11 are present in the second round head-to-head entry matches queue 151, first two electronic entries 11 are submitted to level 1 head-to-head score data point 1 101 matchup, and the score data point 1 value of both electronic entries 11 are compared. If the first electronic entry's 11 score data point 1 value is equal to/or greater than the second electronic entry's 11 score data point 1 value then the first electronic entry 11 wins. If not, then the second electronic entry 11 wins.

The winning entry is submitted to the level 1 winning queue 111. The losing entry is eliminated and an entry results data object 110 is created with the losing electronic entry 11 data, entry id, player id, multiple entry id and the level value set to 2 and the placement value set to 8. The entry results data object 110 is sent to the results queue 50 corresponding to the player id value of the eliminated electronic entry 11.

### Level 2

When two or more electronic entries 11 are present in the level 1 winning queue 111, the first two electronic entries 11 are submitted to the level 2 head-to-head score data point 2 102 match. Then the score data point 2 value of both electronic entries 11 are compared. If the first electronic entry's 11 score data point 2 value is equal to/or greater than the second electronic entry's 11 score data point 2 value, then the first electronic entry 11 wins. If not, then the second electronic entry 11 wins. The winning entry is submitted to the level 2 winning queue 112. The losing entry is eliminated and an entry results data object 110 is created with the losing electronic entry 11 data, entry id, player id, multiple entry id and the level value set to 2 and the placement value set to 7. The entry results data object 110 is sent to the results queue 50 corresponding to the player id value of the eliminated electronic entry 11.

### Level 3

When two or more electronic entries 11 are present in the level 2 winning queue 112, the first two electronic entries 11 are submitted to the level 3 head-to-head score data point 3 103 match. Then the score data point 3 value of both electronic entries 11 are compared. If the first electronic entry's 11 score data point 3 value is equal to/or greater than the second electronic entry's 11 score data point 3 value, then the first electronic entry 11 wins. If not, then the second electronic entry 11 wins. The winning entry is submitted to the level 3 winning queue 113. The losing entry is eliminated and an entry results data object 110 is created with the losing electronic entry 11 data, entry id, player id, multiple entry id and the level value set to 2 and the placement value set to 6. The entry results data object 110 is sent to the results queue 50 corresponding to the player id value of the eliminated electronic entry 11.

### Level 4

When two or more electronic entries 11 are present in the level 3 winning queue 113, the first two electronic entries 11 are submitted to the level 4 head-to-head score data point 4 104 match. Then the score data point 4 value of both electronic entries 11 are compared. If the first electronic entry's 11 score data point 4 value is equal to/or greater than the second electronic entry's 11 score data point 4 value, then the first electronic entry 11 wins. If not, then the second electronic entry 11 wins. The winning entry is submitted to the level 4 winning queue 114. The losing entry is eliminated and an entry results data object 110 is created with the losing electronic entry 11 data, entry id, player id, multiple entry id and the level value set to 2 and the placement value set to 5. The entry results data object 110 is sent to the results queue 50 corresponding to the player id value of the eliminated electronic entry 11.

### Level 5

When two or more electronic entries 11 are present in the level 4 winning queue 114, the first two electronic entries 11 are submitted to the level 5 head-to-head score data point 5 105 match. Then the score data point 5 value of both electronic entries 11 are compared. If the first electronic entry's 11 score data point 5 value is equal to/or greater than the second electronic entry's 11 score data point 5 value, then the first electronic entry wins 11. If not, then the second electronic entry 11 wins. The winning entry is submitted to the level 5 winning queue 115. The losing entry is eliminated and an entry results data object 110 is created with the losing electronic entry 11 data, entry id, player id, multiple entry id and the level value set to 2 and the placement value set to 4. The entry results data object 110 is sent to the results queue 50 corresponding to the player id value of the eliminated electronic entry 11.

### Level 6

When two or more electronic entries 11 are present in the level 5 winning queue 115, the first two electronic entries 11 are submitted to the level 6 head-to-head score data point 6 106 match. Then the score data point 6 value of both electronic entries 11 are compared. If the first electronic entry's 11 score data point 6 value is equal to/or greater than the second electronic entry's 11 score data point 6 value, then the first electronic entry 11 wins. If not, then the second electronic entry 11 wins. The winning entry is submitted to the level 6 winning queue 116. The losing entry is eliminated and an entry results data object 110 is created with the losing electronic entry 11 data, entry id, player id, multiple entry id and the level value set to 2 and the placement value set to 4. The entry results data object 110 is sent to the results queue 50 corresponding to the player id value of the eliminated electronic entry 11.

### Level 7

When two or more electronic entries 11 are present in the level 6 winning queue 116, the first two electronic entries 11 are submitted to the level 7 head-to-head score data point 7 107 match. Then the score data point 7 value of both electronic entries 11 are compared. If the first electronic entry's 11 score data point 7 value is equal to/or greater than the second electronic entry's 11 score data point 7 value, then the first electronic entry 11 wins. If not, then the second electronic entry 11 wins. The winning entry is submitted to the third round head-to-head entry matches queue 152 and a results data object is created with the winning electronic entry's 11 data, entry id, player id, multiple entry id and the level value is set to 2 and the placement value set to 1. The entry results data object 110 is sent to the results queue 50 corresponding to the player id value of the winning electronic entry 11. The losing entry is eliminated and an entry results data object 110 is created with the losing electronic entry 11 data, entry id, player id, multiple entry id and the level value set to 2 and the placement value set to 2. The entry results data object 110 is sent to the results queue 50 corresponding to the player id value of the eliminated electronic entry 11.

FIG. 4c shows the flow for round 3 of the Head-to-Head score data point entry matches, described in detail by level below:

### Level 1

When two or more electronic entries 11 are present in the second round head-to-head entry matches queue 152, first two electronic entries 11 are submitted to level 1 head-to-head score data point 1 101 matchup, and the score data point 1 value of both electronic entries 11 are compared. If the first electronic entry's 11 score data point 1 value is equal to/or greater than the second electronic entry's 11 score data point 1 value then the first electronic entry 11 wins. If not, then the second electronic entry 11 wins.

The winning entry is submitted to the level 1 winning queue 111. The losing entry is eliminated and an entry results data object 110 is created with the losing electronic entry 11 data, entry id, player id, multiple entry id and the level value set to 3 and the placement value set to 8. The entry results data object 110 is sent to the results queue 50 corresponding to the player id value of the eliminated electronic entry 11.

### Level 2

When two or more electronic entries 11 are present in the level 1 winning queue 111, the first two electronic entries 11 are submitted to the level 2 head-to-head score data point 2 102 match. Then the score data point 2 value of both electronic entries 11 are compared. If the first electronic entry's 11 score data point 2 value is equal to/or greater than the second electronic entry's 11 score data point 2 value, then the first electronic entry 11 wins. If not, then the second electronic entry 11 wins. The winning entry is submitted to the level 3 winning queue 112. The losing entry is eliminated and an entry results data object 110 is created with the losing electronic entry 11 data, entry id, player id, multiple entry id and the level value set to 3 and the placement value set to 7. The entry results object 110 is sent to the results queue 50 corresponding to the player id value of the eliminated electronic entry 11.

### Level 3

When two or more electronic entries 11 are present in the level 2 winning queue 112, the first two electronic entries 11 are submitted to the level 3 head-to-head score data point 3 103 match. Then the score data point 3 value of both electronic entries 11 are compared. If the first electronic entry's 11 score data point 3 value is equal to/or greater than the second electronic entry's 11 score data point 3 value, then the first electronic entry 11 wins. If not, then the second electronic entry 11 wins. The winning entry is submitted to the level 3 winning queue 113. The losing entry is eliminated and an entry results data object 110 is created with the losing electronic entry 11 data, entry id, player id, multiple entry id and the level value set to 3 and the placement value set to 6. The entry results data object 110 is sent to the results queue 50 corresponding to the player id value of the eliminated electronic entry 11.

### Level 4

When two or more electronic entries 11 are present in the level 3 winning queue 113, the first two electronic entries 11 are submitted to the level 4 head-to-head score data point 4 104 match. Then the score data point 4 value of both electronic entries 11 are compared. If the first electronic entry's 11 score data point 4 value is equal to/or greater than the second electronic entry's 11 score data point 4 value, then the first electronic entry 11 wins. If not, then the second electronic entry 11 wins. The winning entry is submitted to the level 4 winning queue 114. The losing entry is eliminated and an entry results data object 110 is created with the losing electronic entry 11 data, entry id, player id, multiple entry id and the level value set to 3 and the placement value set to 5. The entry results data object 110 is sent to the results queue 50 corresponding to the player id value of the eliminated electronic entry 11.

### Level 5

When two or more electronic entries 11 are present in the level 4 winning queue 114, the first two electronic entries 11 are submitted to the level 5 head-to-head score data point 5 105 match. Then the score data point 5 value of both electronic entries 11 are compared. If the first electronic entry's 11 score data point 5 value is equal to/or greater than the second electronic entry's 11 score data point 5 value, then the first electronic entry 11 wins. If not, then the second electronic entry 11 wins. The winning entry is submitted to the level 5 winning queue 115. The losing entry is eliminated and an entry results data object 110 is created with the losing electronic entry 11 data, entry id, player id, multiple entry id and the level value set to 3 and the placement value set to 4. The entry results data object 110 is sent to the results queue 50 corresponding to the player id value of the eliminated electronic entry 11.

### Level 6

When two or more electronic entries are present in the level 5 winning queue 115, the first two electronic entries 11 are submitted to the level 6 head-to-head score data point 6 106 match. Then the score data point 6 value of both electronic entries 11 are compared. If the first electronic entry's 11 score data point 6 value is equal to/or greater than the second electronic entry's 11 score data point 6 value, then the first electronic entry 11 wins. If not, then the second electronic entry 11 wins. The winning entry is submitted to the level 6 winning queue 116. The losing entry is eliminated and an entry results data object 110 is created with the losing electronic entry 11 data, entry id, player id, multiple entry id and the level value set to 3 and the placement value set to 4. The entry results data object 110 is sent to the results queue 50 corresponding to the player id value of the eliminated electronic entry 11.

### Level 7

When two or more electronic entries 11 are present in the level 6 winning queue 116, the first two electronic entries 11 are submitted to the level 7 head-to-head score data point 7 107 match. Then the score data point 7 value of both electronic entries 11 are compared. If the first electronic entry's 11 score data point 7 value is equal to/or greater than the second electronic entry's 11 score data point 7 value, then the first electronic entry 11 wins. If not, then the second electronic entry 11 wins. The winning entry is submitted to the third round head-to-head entry matches 153 queue and a results data object is created with the winning electronic entry's 11 data, entry id, player id, multiple entry id and the level value is set to 3 and the placement value set to 1. The entry results data object 110 is sent to the results queue 50 corresponding to the player id value of the winning electronic entry 11. The losing entry is eliminated and an entry results data object 110 is created with the losing electronic entry 11 data, entry id, player id, multiple entry id and the level value set to 3 and the placement value set to 2. The entry results data object 110 is sent to the results queue 5, corresponding to the player id value of the eliminated electronic entry 11.

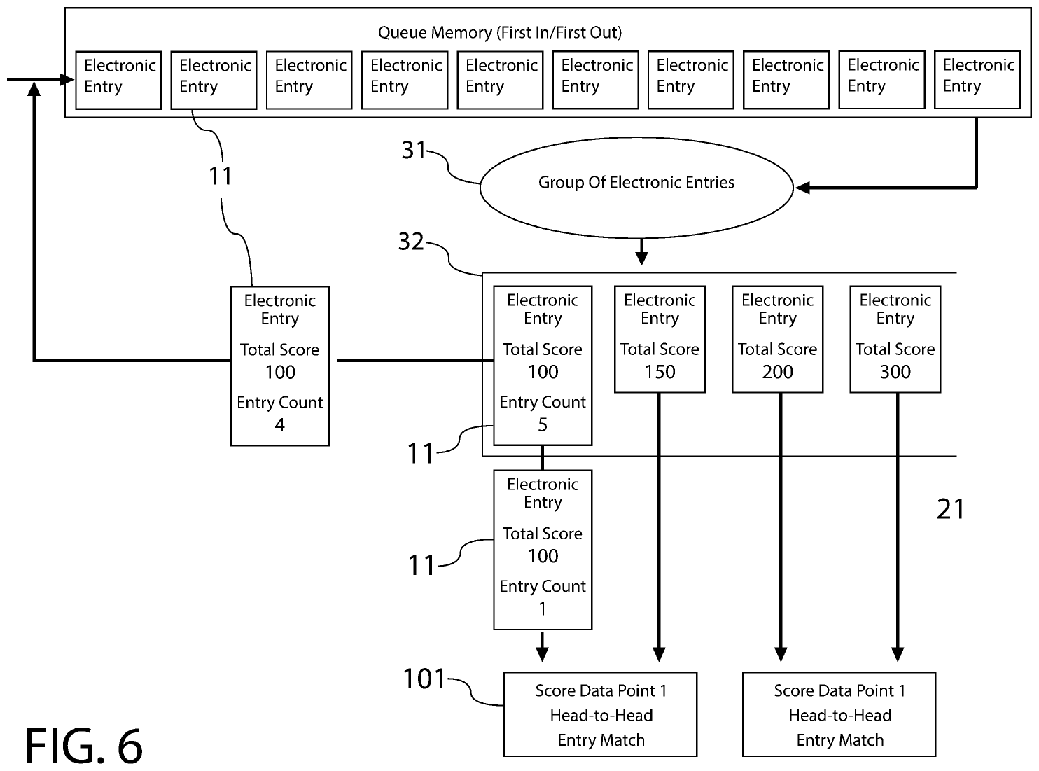

FIG. 6 shows the procedure for dealing with multiple entries. When an electronic entry 11 that represents multiple entries is selected to be submitted to the score data point 1 head-to-head entry 101 matches, in this example, an electronic entry 11 representing five entries has been selected to be sent to the score data point 1 head-to-head entry matches 101. What happens is only a single electronic entry 11 is sent to the score data point 1 head-to-head entry matches 101 and an electronic entry 11 data object is created with the entry count of four, representing the remaining four entries, and is submitted back to the scoring queue 20.

### Second Embodiment

In another implementation, the contest is a contest in which the electronic entry 11 with the lowest scores wins.

In this implementation, the contest is linked to a lottery and only losing tickets are entered into competitive contest 10. In competitive contest 10, there is one score data point for each number drawn in the lottery. Each number drawn is compared to each respective number guessed by the competitor. The total score represents a comparison between all drawn lottery numbers and their respective score data points. The goal of the contest is to minimize the difference between the drawn lottery numbers and the score data points. In this implementation, the lower score wins.

FIG. 1 illustrates the flow of the 11 electronic entry and the returning of the competitive entry results 110. In this implementation, competitive contest 10 creates electronic entries 11 and pulls entry results data object 110 from results queue 50. Competitive contest 10 only submits an electronic entry 11 representing a single entry into scoring queue 20. Competitive contest 10 runs on a computerized lottery terminal and lottery servers.

Once a contestant completes competitive contest 10, an electronic entry 11 is created in the form of a data object. In one implementation, the data object, contains six scoring data points, a total score, and an entry Id.

Upon completion of electronic entry 11 it is transmitted to scoring queue memory 20. In some implementations, scoring queue memory 20 is a first in/first out queue (“FIFO”).

Scoring system 30 contains handicapping and seeding system 33 that uses the total score value as a handicapping tool and a system for head-to-head score data point entry matches 100 uses electronic entry 11's scoring data points to determine winners and losers. Head-to-head entry matches 100 produces entry results data object 110.

Handicapping and seeding system 33 may determine handicap depending on factors such as a competitor's propensity to quit as determined from behavior in previous competitions, rounds, or performance within a round. Handicapping and seeding system 33 may additionally consider a demographic of the competitor. For instance, competitors with certain demographic features may be especially likely to quit a competition if they do not win anything within several rounds. These demographic features can in some instances be obtained using a location or address of a competitor's device. The system can automatically adjust handicaps and seeding to increase a probability that such competitors will always win a small amount during the initial rounds without substantively affecting the integrity of the competition or the prize pool. The handicapping and seeding system can also recompute a handicap of a player during the score data point entry matches 100 such that a player performing poorly is less likely to quit.

Handicapping and seeding system 33 obtains groups of electronic entries 11 from scoring queue memory 20 and the sorts electronic entries 11 by total score. This produces a sorted list 32 of electronic entries 11. The electronic entries with the two highest total scores are submitted to head-to-head score data point entry matches 100.

Head-to-head score data point entry matches 100 creates entry results data object 110 once an electronic entry 11 has been eliminated or, in this implementation, when an electronic entry 11 has successfully defeated a fixed number of other electronic entries.

Upon creation of the entry results data object 110, the head-to-head score data point entry 100 matches transmits the entry results data object 110 to results queue memory 50.

In this implementation, results queue 50 is a single cloud base queue that the competitive contest 10 obtains entry results data objects 110 as they are available. Competitive contest 10 awards prizes based on entry results data object 110. But results queue 50 may be modified from a standard queue to increase player engagement. In some implementations, it is desirable to change the order in which entry results are reported. For example, the competition may end at a certain time at which a large prize should be announced. The large prize entry result can therefore be moved to accommodate this announcement. Additionally, advertisers may be interested in purchasing advertising space associated with a large prize announcement. The advertising schedule may be constrained by the program content such as a sports game, making it necessary to time announcement of an entry results such that it corresponds with the advertising schedule. Entry results in results queue 50 can therefore be rearranged as necessary in some implementations to accommodate scheduling needs.

Prizes awarded to each competitor based on entry results data object 110 can further be modified automatically by the system based on various factors. For instance, some competitors may be much more likely to participate in a future competition if they receive a certain level price. Therefore, in some implementations, a prize awarded to a competitor may be dynamically adjusted by the system based on the competitor's prior performance in competitions and behavior thereafter. If a competitor always quits competing for months after they do not win a prize, the system can adjust the prize given such that the player is retained. Such a price adjustment can come from a pool designated at the outset of the competition for the purpose of increasing competitor retention. In this way, the system still knows how much prize money it has available before the contest begins, but some is allocated differently.

In some instances, the system may dynamically sell advertising placements to further fund a competitor's prize. For example, the system could display advertisements to a competitor during the competition, receiving advertising revenue. At the time a prize is distributed to a competitor, the system displays another advertisement, indicating the additional prize portion provided by an advertising revenue. This final advertising placement associated with the prize can be sold to advertisers for a price depending on the prize awarded. For example, an advertiser may highly value being associated with a large prize award to a competitor. The system may therefore sell advertising space after the prize to be awarded is calculated.

This implementation is an ongoing competitive contest 10 that continues through each new lottery drawing with electronic entries 11 capable of competing with electronic entries 11 from other lottery drawing periods. The scoring system 30 is design to operate continuously, processing, scoring and returning results for an unlimited number of electronic entries 11. In this implementation, the electronic entry 11 status may be returned to the competitive contest 10.

The number of rounds and head-to-head levels is determined dynamically by the system and may depend upon a variety of factors, such as the intended duration of the contest, anticipated number of entrants, desired size of the prize pool, geographic location of the competitors, and the like.

FIG. 2 shows examples of two implementations of electronic entries. The second 12 electronic entry is used in this embodiment and the second 12 electronic entry used in the next embodiment.

Electronic entries can be modified with custom data to fit the needs of different types of competitive contest but for this disclosure they must contain at a minimum an entry id, a total score and at least two score data points. In an implementation, electronic entry 11 includes an Entry ID, a Total Score, and at least one Score Datapoint. For example, in one implementation, there are six score data points, with each point representing a result of ⅙^{th} of a competitive contest.

The number of data points associated with an electronic entry may be automatically modified based on an additional fee paid by a competitor. This can allow for differently priced electronic entries to have additional chances to win. Furthermore, an electronic entry can be eligible for different rounds of the competition depending upon additional custom data included. For example, a competitor may wish to pay a larger entry fee to bypass certain rounds of the competition and increase their odds of winning. This is a computationally efficient method of simulating the effects of buying a large number of entries, without having to calculate the outcome of numerous entries competing in earlier rounds, especially in contests of pure luck. This technique can be factored in from the start of the competition to ensure it does not substantively affect the total prize pool or the competitive integrity of competition.

FIG. 5 depicts electronic entry results 110 and 120 according to some implementations. Electronic entry results 120 contains an entry id, a placement number, and level according to one implementation. The Entry Id is a unique identifier for the entry. The placement number indicates the number of times an entry has won in head-to-head match as discussed with respect to FIG. 4 above. The level number indicates the round in which the placement value was earned.

Electronic entry results 110 further contains a player Id, uniquely identifying a competitor associated with the entry. It also contains a multiple entry Id, identifying the number of the entry within a set of entries.

As described above, electronic entries may contain additional data indicating special privileges provided to a competitor or entry.

FIG. 4 depicts the flow for the Head-to-Head score data point entry matches, described in detail with respect to each level below:

### Head-to-Head Score Data Point Matches

### Level 1

When two electronic entries 11 are submitted to level 1 head-to-head score data point 1 101 match, the score data point 1 value of both electronic entries 11 are compared. If the first electronic entry's 11 score data point 1 value is equal to/or lessor than the second electronic entry's 11 score data point 1 value then the first electronic entry 11 wins. If not, then the second electronic entry 11 wins.

The winning entry is submitted to the level 1 winning queue 111. The losing electronic entry 11 is eliminated and an entry results data object 110 is created with the losing electronic entry 11 data, entry id, and the level value set to 1 and the placement value set to 7. The entry results data object 110 is sent to the results queue 50.

### Level 2

When two or more electronic entries 11 are present in the level 1 winning queue 111, the first two electronic entries 11 are submitted to the level 2 head-to-head score data point 2 102 match. Then the score data point 2 value of both electronic entries 11 are compared. If the first electronic entry's 11 score data point 2 value is equal to/or lessor than the second electronic entry's 11 score data point 2 value, then the first electronic entry 11 wins. If not, then the second electronic entry 11 wins. The winning entry is submitted to the level 2 winning queue 112. The losing entry is eliminated and an entry results data object 110 is created with the losing electronic entry 11 data, entry id, and the level value set to 1 and the placement value set to 6. The entry results data object 110 is sent to the results queue 50.

### Level 3

When two or more electronic entries 11 are present in the level 2 winning queue 112, the first two electronic entries 11 are submitted to the level 3 head-to-head score data point 3 103 match. Then the score data point 3 value of both electronic entries 11 are compared. If the first electronic entry's 11 score data point 3 value is equal to/or lessor than the second electronic entry's 11 score data point 3 value, then the first electronic entry 11 wins. If not, then the second electronic entry 11 wins. The winning entry is submitted to the level 3 winning queue 113. The losing entry is eliminated and an entry results data object 110 is created with the losing electronic entry 11 data, entry id, and the level value set to 1 and the placement value set to 5. The entry results data object 110 is sent to the results queue 50.

### Level 4

When two or more electronic entries 11 are present in the level 3 winning queue 113, the first two electronic entries 11 are submitted to the level 4 head-to-head score data point 4 104 match. Then the score data point 4 value of both electronic entries 11 are compared. If the first electronic entry's 11 score data point 4 value is equal to/or lessor than the second electronic entry's 11 score data point 4 value, then the first electronic entry 11 wins. If not, then the second electronic entry 11 wins. The winning entry is submitted to the level 4 winning queue 114. The losing entry is eliminated and an entry results data object 110 is created with the losing electronic entry 11 data, entry id, entry id and the level value set to 1 and the placement value set to 4. The entry results data object 110 is sent to the results queue 50.

### Level 5

When two or more electronic entries 11 are present in the level 4 winning queue 114, the first two electronic entries 11 are submitted to the level 5 head-to-head score data point 5 105 match. Then the score data point 5 value of both electronic entries 11 are compared. If the first electronic entry's 11 score data point 5 value is equal to/or lessor than the second electronic entry's 11 score data point 5 value, then the first electronic entry 11 wins. If not, then the second electronic entry 11 wins. The winning entry is submitted to the level 5 winning queue 115. The losing entry is eliminated and an entry results data object 110 is created with the losing electronic entry 11 data, entry id, and the level value set to 1 and the placement value set to 2. The entry results data object 110 is sent to the results queue 50.

### Level 6

When two or more electronic entries 11 are present in the level 5 winning queue 115, the first two electronic entries 11 are submitted to the level 6 head-to-head score data point 6 106 match. Then the score data point 6 value of both electronic entries 11 are compared. If the first electronic entry's 11 score data point 6 value is equal to/or lessor than the second electronic entry's 11 score data point 6 value, then the first electronic entry 11 wins. If not, then the second electronic entry 11 wins. The winning entry maybe submitted to the optional new round of head-to-head entry matches 150. An entry results data object 110 is created with the winning electronic entry's 11 data, entry id and the level value set to 1 and the placement value set to 1. The entry results data object 110 is sent to the results queue 50. The losing entry is eliminated and an entry results data object 110 is created with the losing electronic entry 11 data, entry id, and the level value set to 1 and the placement value set to 2. The entry results data object 110 is sent to the corresponding results queue 50.

1. A system, comprising:
one or more memories collectively configured to store computer instructions; and
a processor system configured to execute the computer instructions to:
obtain, from a competitor, a select entry;
compute a first-round score for the select entry based on its performance in a first round of a contest;
rank the select entry relative to a plurality of contest entries based on the first-round score;
dynamically establish for a second round of the contest, based on the rank, a head-to-head match between the select entry and a second-round competing entry in the plurality of contest entries;
compute a second-round score for the select entry based on its performance in the second round of the contest;
determine a total score for the select entry based on the first-round score and the second-round score;
compute a prize to be distributed to the competitor based on the total score and a count of the plurality of contest entries; and
in response to determining that the count of the plurality of entries is above a threshold, distribute the prize to the competitor.

2. The system of claim 1, wherein the processor system is further configured to:
compute the prize to be distributed based on a demographic of the competitor.

3. The system of claim 1, wherein the processor system is further configured to:
compute the prize to be distributed based on a level of experience of the competitor with respect to the contest.

4. The system of claim 1, wherein the processor system is further configured to:
in response to determining that a score of the select entry is greater than a score of the second-round competing entry in the head-to-head match:
place the second-round competing entry into a results queue; and
place the select entry into a third round of the contest.

5. The system of claim 1, wherein the contest is a contest of luck.

6. The system of claim 1, wherein the processor system distributes the prize to the competitor in response to determining content to be associated with distributing the prize.

7. The system of claim 1, wherein the processor system is further configured to:
in response to determining that the second-round score of the select entry is greater than a second-round score of the second-round competing entry:
submit the select entry to a third round of the contest; and
submit the second-round competing entry to a results queue.

8. The system of claim 1, wherein the processor system is further configured to:
compute a second-round score of the competing entry;
in response to determining that the second-round score of the select entry is less than the second-round score of the second-round competing entry:
submit the select entry to a results queue; and
submit the second-round competing entry to a third round of the contest.

9. The system of claim 1, wherein the processor system is further configured to:
compute a second-round score of the second-round competing entry;
in response to determining that the second-round score of the select entry is greater than the second-round score of the second-round competing entry:
submit the second-round competing entry to a results queue; and
submit the select entry to a third round of the competition, wherein a head-to-head matchup of the select entry is based on the second-round score of the select entry.

10. The system of claim 1, wherein the first round of the contest corresponds to a portion of an event.

11. The system of claim 1, wherein the processor system is further configured to:
compute a second-round score of the second-round competing entry;
in response to determining that the second-round score of the select entry is greater than the second-round score of the second-round competing entry:
submit the second-round competing entry to a results queue;
submit the select entry to a third round of the competition;
sorting the third-round contest entries based on their respective second-round scores; and
selecting, based on the sorting, a third-round contest entry in the plurality of third-round contest entries to be in a head-to-head match with the select entry.

12. A method comprising:
determining, for each of a plurality of rounds of a competition, a minimum number of contest entries to distribute a prize at the round of the competition;
obtaining, from a competitor, a select entry;
computing a first-round score for the select entry based on its performance in a first round of the competition;
dynamically establishing for the second round of the competition, based on the first-round score, a head-to-head match between the select entry and a second-round competing entry in the plurality of competition entries;
computing a second-round score for the select entry based on its performance in the second round of the competition;
determining a total score for the select entry based on the first score and the second score;
computing a prize to be distributed to the competitor; and
in response to determining that the minimum number of contest entries corresponding to the second round is satisfied, distributing the prize to the competitor.

13. The method of claim 12, further comprising:
computing the prize to be distributed to the competitor based on a level of experience of the competitor with respect to the competition.

14. The method of claim 12, wherein dynamically establishing the head-to-head match between the select entry and the second-round competing entry comprises:
sorting the plurality of competition entries based on a plurality of first-round scores that correspond to performances of the plurality of competition entries in the first round; and
selecting, based on the sorting, the second-round competing entry.

15. The method of claim 12, further comprising:
in response to determining that the second-round score of the select entry is less than a second-round score of the second-round competing entry:
submitting the second-round competing entry to a third round of the competition; and
removing the select entry from the competition.

16. The method of claim 12, further comprising:
computing a second-round score of the second-round competing entry;
in response to determining that the second-round score of the select entry is greater than the second-round score of the second-round competing entry:
submitting the select entry to a third round of the competition; and
in response to determining that a third-round competing entry has a second-round score within a point threshold of the second-round score of the select entry, establishing a head-to-head matchup between the select entry and the third-round competing entry.

17. The method of claim 12, wherein the demographic of the competitor is a skill level of the competitor with respect to the competition.

18. One or more memories collectively storing instructions that, when executed by one or more processors in a computing system, cause the one or more processors to perform a method, the method comprising:
determining, for each of a plurality of rounds of a competition, a minimum number of contest entries to distribute a prize at the round of the competition;
dynamically establishing for a second round of the competition, based on a first-round score of the select entry, a head-to-head match between the select entry and a second-round competing entry;
determining that a second-round score for the select entry is greater than a second-round score for the second-round competing entry;
calculating a value of the prize to be distributed to the competitor based on the second-round score of the select entry; and
in response to a count of competition entries in the second round of the competition exceeding the minimum number of competition entries for the second round of the competition, distributing the prize to the competitor.

19. The one or more memories of claim 18, wherein each competition entry in the second round of the competition won a head-to-head match in the first round of the competition.

20. The one or more memories of claim 18, wherein dynamically establishing a head-to-head match between the select entry and the second-round competing entry comprises:
sorting second-round entries based on their first-round scores; and
selecting, as the second-round competing entry, an entry in the second-round entries with a closest first round score to the first-round score of the select entry.
